(19) United States
(12) Patent Application Publication
(10) Pub. No.: US 2011/0042461 A1
(43) Pub. Date: Feb. 24, 2011

(54) Numeric Dial Quantity Input Device Embedded Bar Cod Scanner

(76) Inventor: I-Yu CHEN, San-Chung City (TW)

Correspondence Address: HDLS IPR Services, PO Box 220746, Chantilly, VA, 20153, US

(21) Appl. No.: 12/545,858

(22) Filed: Aug. 23, 2009

(51) Int. Cl. G06K 7/10

(52) U.S. Cl. 235/462.01; 235/462.45

(57) ABSTRACT

A bar code scanner with an embedded numeric dial quantity input device to input quantity includes a bar code scanner and a numeric dial. The dial has a reference scale around it to represent a specific number. The desired number is set by turning the dial. User can count the quantity of an item and input the number with the numeric dial before or after scanning it to store the correct quantity of such item. This can avoid entering quantity at the register or POS machine and simplifies the operation.

### BACKGROUND OF THE INVENTION

1. Field of the Invention

This invention relates to a bar code scanner being special for having a numeric dial embedded on it and the keypad buttons are arranged and programmed to help users to operate easily and scan multiple items with different quantity, so as to save the time for entering quantity at the registry or POS (point of sale) machine and avoid unnecessary operating errors to speed up the cashier process.

2. Description of the Prior Art

The common-used bar code scanner 8 as illustrated in FIG. 6 has a handle 81 and a bar code reader 82. The bar code reader 82 is positioned at the front end of the handle 81. User holds the handle 81 and aimed the bar code reader 82 close to a bar code, the bar code reader 82 scans the bar code with the optical sensor inside it, converts the scanned bar code into digital data, and compares the data with the database to obtain useable data.

When an item has a bar code that represents its information on it, user can use the common bar code scanner 8 to quickly obtain its data without manual work to save time especially when counting multiple items. This bar code scanner 8 is a must-have for mercantile, warehouse management, cashier, and many other places.

This common used bar code scanner 8 is rarely improved although it has been used for so long. Most of the research and developments are within improving the optical scanning/reading technology and the database system but not on the bar code scanner 8 itself.

Bar code scanner can be divided into two types. The first is the usual bar code scanner and the second is the common data collector, also known as handy terminal.

The bar code scanner 8 is mainly used for counting multiple different items so theoretically every single item should be scanned once to meet this purpose, but in order to save time, if the quantity of an item can be quickly counted, user can just scan the item once and enter the quantity of it on the cashier machine or the POS keypad before or after scanning it, and the system will have the data and correct quantity of the item. This scenario is very usual at any retail store and supermarket. When a customer purchased many items with different quantity, if the cashier scans every single item, it not only takes more time, the receipt is also hard to read.

The drawback of the common bar code scanner 8 is that it has no quantity input function. To enter the quantity of an item is done by the backend cashier connected to the bar code scanner 8. Which means the user must put down the bar code scanner 8 after counting the quantity, punched in the number, and pick up the bar code scanner 8 again to scan the next item. The only problem of this method is it is not convenient and takes more time.

The data collector is designed for storing the quantity of items. While having numeric buttons to enter quantity, the data must be transferred to the backend system to be used and processed. It is good for inventory control but does not help retail or supermarket checkout where many items with different quantity occurs with almost every customer.

For all these reasons, the inventor designed a bar code scanner embedded with numeric dial quantity input device to meet the need for many items with different quantity scenario occurring everyday at the retail and supermarket cashier. It is designed to provide convenience so the user does not have to perform the routine of putting down the bar code scanner, punch in the quantity at the POS or cashier machine, and pick up the bar code scanner again, as to raise the bar code scanner usage and speed up the cashing process. This invention of bar code scanner with numeric keypad is developed and invented based on long term research and investigation.

### SUMMARY OF THE INVENTION

The primary objective of this invention is to provide a numeric dial quantity input device embedded bar code scanner which simplifies working process, increase scanning efficiency, and to quickly count and obtain data for multiple items with different quantity.

The further objective of this invention is to provide a numeric dial quantity input device embedded bar code scanner to reduce redundant body movement such as putting down the scanner, entering the quantity to the cashier machine, and picking up the scanner again. By minimizing these movements will also reduce human errors.

Yet another objective of this invention is to provide a numeric dial quantity input device embedded bar code scanner which is easy to use so the users do not need to spend too much time on learning it. The numeric dial quantity input device can be programmed to suite the users' habit and adjust the direction of the dial or its angle for the users to use the bar code scanner effectively.

The numeric dial quantity input device embedded bar code scanner that serves the described purposes has a bar code scanning device and a numeric dial embedded on the surface of the scanner. The quantity number is set by sensing the angle movement when the dial is turned. There is a monitor to display the number set by the current dial position. The number is changed according the direction it is turned and the angel movement of the dial, and is instantly displayed on the screen. Users confirm the quantity of an item and use the dial to enter the quantity of the item before or after scanning it to record the correct quantity for an item to avoid entering the number at the registry or the POS machine to simply the process.

### BRIEF DESCRIPTION OF THE DRAWINGS

FIG. 1 shows a perspective view of this invention of numeric dial quantity input device embedded bar code scanner;

FIG. 2 shows a vertical view of this invention of numeric dial quantity input device embedded bar code scanner;

FIG. 3 shows this invention of numeric dial quantity input device embedded bar code scanner with hidden function keys;

FIG. 4 shows this invention of numeric dial quantity input device embedded bar code scanner with integrated LED indicators on the dial;

FIG. 5 shows an usage example of this invention of numeric dial quantity input device embedded bar code scanner; and

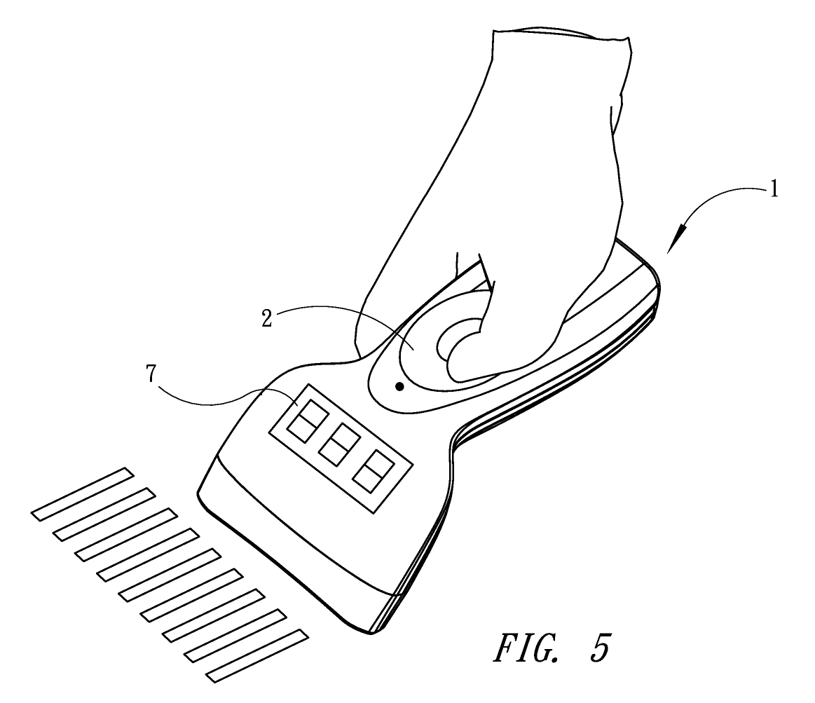

FIG. 6 shows an usage example of common bar code scanner.

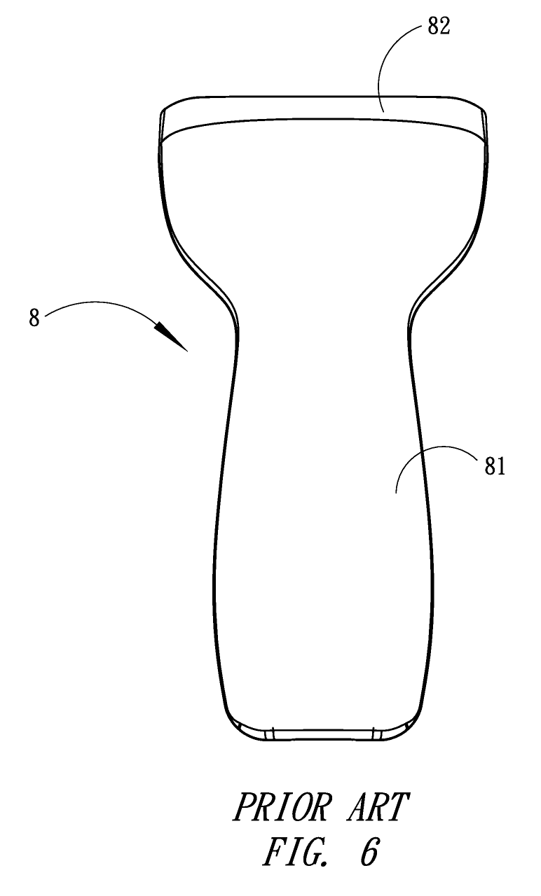

### DETAILED DESCRIPTION OF THE PREFERRED EMBODIMENT

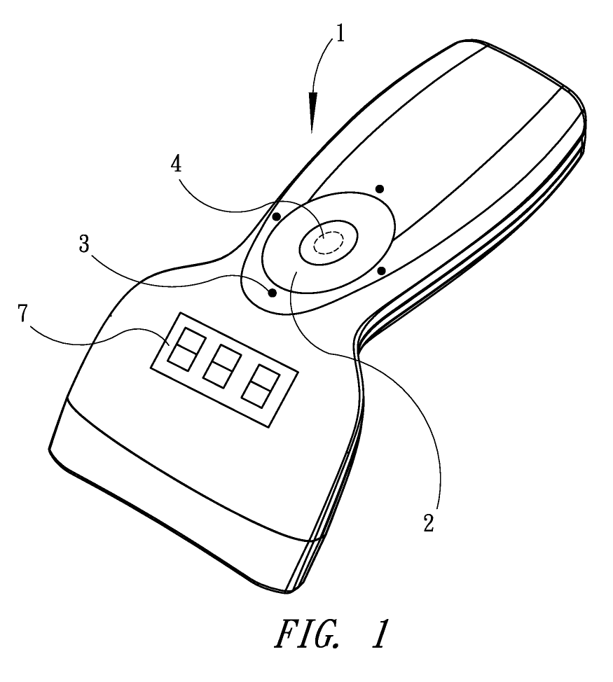

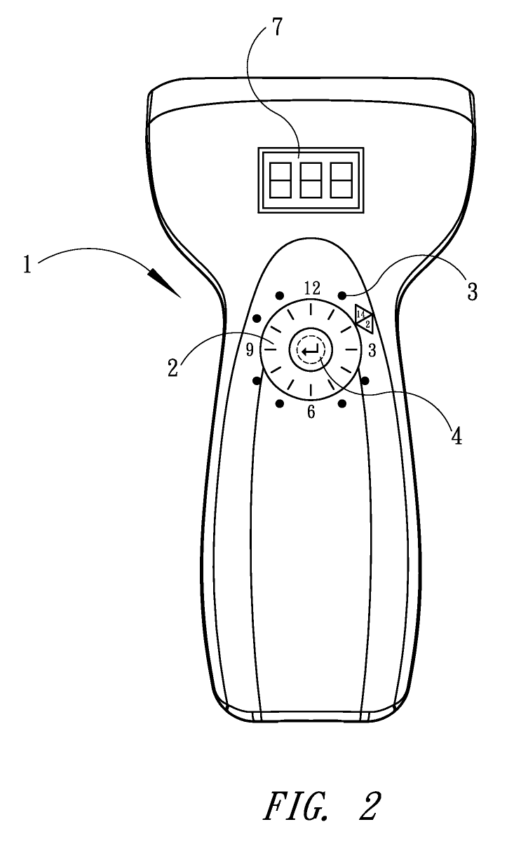

FIG. 1 and FIG. 2 show the numeric dial quantity input device embedded bar code scanner of this invention. It has a bar code scanner 1, a numeric dial on the surface of the bar code, and an LCD or LED display screen 7 embedded on it.

The bar code scanner 1 is the same as common bar code scanner as seen in the market so there will be no further description. What is special for this invention is the design of the numeric dial 2. This numeric dial 2 is positioned on the surface of the bar code scanner 1 and a circle of reference scale 3 around it. This example adopts the scale of the clock which is familiar to everyone for easier adoption. This reference scale can be based on any scale. A confirm button 4 can be placed in the center of the numeric dial 2 to confirm the number entered. The LCD or LED display screen 7 is placed on the surface of the bar code scanner 1 where it is easy to read, like in front of the numeric dial 2, to show the number entered.

The method for using this bar code scanner 1 includes:

1. When the quantity of an item to scan is one, it is used the same as common bar code scanner. Just use the bar code scanner 1 and there is no need to turn the numeric dial 2 or pressing the confirm button 4.

2. When the quantity of an item to scan is two, it is entered by pressing the confirm button 4 without turning the numeric dial 2 because the initial value for the confirm button 4 is set to two.

3. The reference scale 3 uses the two o'clock position as the starting number. The numeric dial 2 has its initial values and is programmed to increase or decrease the number by turning the dial clockwise or counterclockwise. This example uses the two o'clock position as the starting point and the initial value is two. When the dial is turned clockwise, the number is increased by one for each step. When the dial is turned counterclockwise, the initial value will change to fourteen and is decreased by one for each step.

4. As mentioned, when the quantity is more than two, touch the two o'clock position of the numeric dial 2 as the starting point, then turn the dial clockwise one step to change the number from two to three, and so on.

5. If the quantity is a larger number, touch the two o'clock position of the numeric dial in the same way to set the starting point, and then turn the dial counterclockwise to decrease the number from fourteen to thirteen, and so on.

6. While turning the dial, user can change the turning direction at any time to change the number from increasing to decreasing and vice versa.

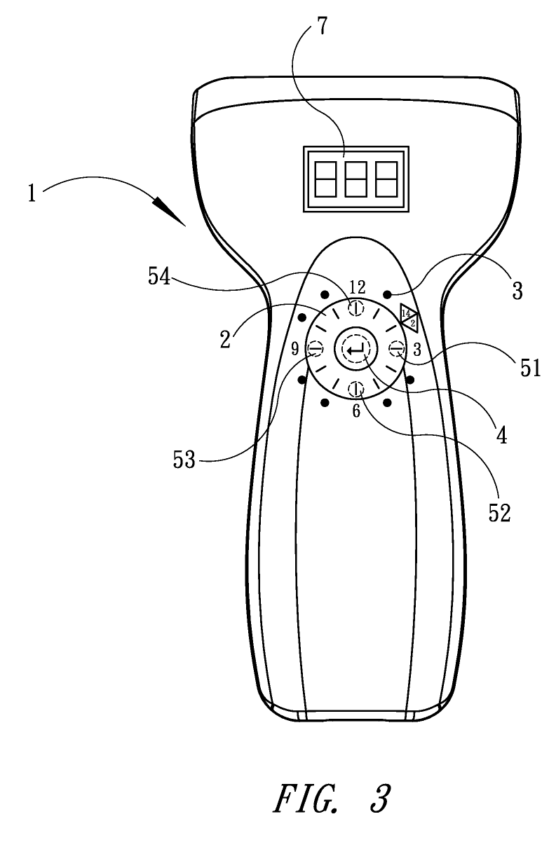

For the case of entering larger quantity, this invention can add four hidden function keys 51, 52, 53, 54 on the bar code scanner 1 as seen in FIG. 3. These function keys are placed under the three, six, nine, and twelve o'clock position of the numeric dial 2. For example the hidden function key 51 at the three-o'clock position adjusts the ones; the hidden function key 52 at the six-o'clock position adjusts the tens; the hidden function key 53 at the three-o'clock position adjusts the hundreds.

By pressing the nine o'clock position of the numeric dial 2 and turn the numeric dial 2, the function of the hidden function key 53 is activated and the hundreds is changed by the dial, meaning the quantity is changed by one hundred for each step the dial moved. After the hundreds is set, user can press the six o'clock position hidden function key 52 to change the tens. Each step of the dial movement changes the quantity by ten. Then by pressing the hidden function key 51 at the three o'clock position of the numeric dial 2, user can change the ones with the numeric dial 2. After all digits are set, pressing the confirm button 4 will set the quantity desired. The hidden function key 54 at the twelve o'clock position is the clear button which will clear the LCD or LED display screen 7 back to zero and reset the hidden function keys 51, 52, 53 to their initial values.

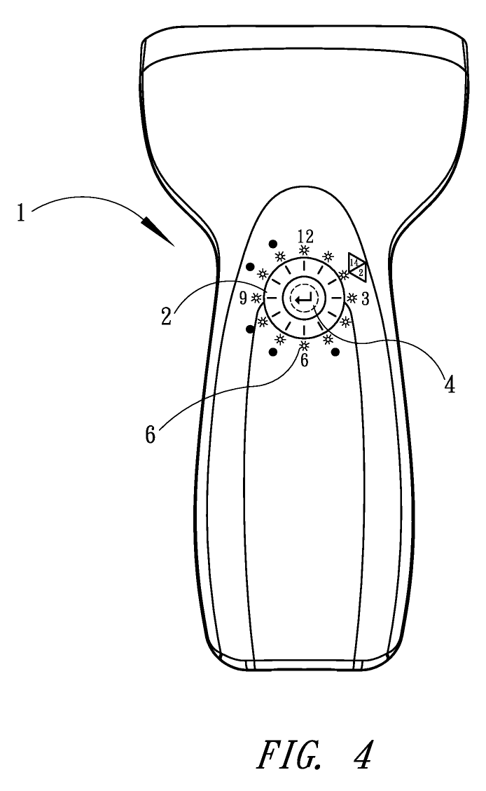

Besides the LCD or LED display screen 7, this invention can use LED indicator 6 on the bar code scanner 1 as shown in FIG. 4. There are twelve LED indicators 6 along with the clock and reference scale 3. These LED indicators 6 can represent the quantity by on, blink, off, or changing colors. This example can handle the quantity up to twenty-four.

When the input quantity is three and more, user can start from the two o'clock position or where the ∇ mark is and go clockwise. The initial value is two and increased by one for each step, and the LED indicator 6 at the three o'clock position will become on. The number becomes three after turning one step. If the dial is turned counterclockwise, the initial value is fourteen and the number is decreased by one for each step. The number becomes thirteen after turning one step, and the LED indicator 6 at the one o'clock position will become blinking, and so on. The smallest number is one. It continues until the confirm button 4 is pressed and the LED indicators 6 are off. The pattern for the LED indicators 6 and be: one to twelve is represented by “on” and thirteen to twenty-four is represented by “blinking”; or one to twelve is red and thirteen to twenty-four is green.

The mentioned numeric dial 2 has press switch function for entering number. The turning step for the numeric dial 2 could be controlled by mechanical (contact), optical (diaphragm), or magnetic method to adjust the number. The numeric dial 2 also has stepping mechanism. The usual ways are latch and click. When the numeric dial 2 is turned, user will feel the click and hold from the dial to perform the adjustment of the dial. These functions are all matured technology and are not designed for or controlled by this invention so there will be no further descriptions.

The aforementioned descriptions are solely for explaining the embodiments of the present invention and are not intended to limit the scope of the present invention. Any equivalent practice of modification within the spirit of the present invention should be treated as being within the scope of patent of the present invention.

What is claimed is:

1. A numeric dial quantity input device embedded bar code scanner comprising:
a bar code scanner; and
a numeric dial embedded on the surface of the bar code scanner to set a predetermined number and a confirm button at the center of the dial to confirm the number, and to enter the number by pressing the confirm button.

2. The numeric dial quantity input device embedded bar code scanner as claimed in claim 1, wherein the numeric dial has an initial value and is configured to be increased or decreased by turning the dial clockwise or counterclockwise respectively.

3. The numeric dial quantity input device embedded bar code scanner as claimed in claim 1, wherein the numeric dial has hidden function keys under the dial for enter or cancel function.

4. The numeric dial quantity input device embedded bar code scanner as claimed in claim 1, wherein the numeric dial is mechanically, optically, or magnetically controlled to sense the turning steps.

5. The numeric dial quantity input device embedded bar code scanner as claimed in claim 1, wherein the numeric dial has stepping mechanism for the dial being turned and positioned at certain positions to determine the quantity for input.

6. The numeric dial quantity input device embedded bar code scanner as claimed in claim 1, wherein the bar code scanner is configured to have LED indicator to show the dial status by on, off, blinking, or changing colors.

7. The numeric dial quantity input device embedded bar code scanner as claimed in claim 1, wherein the bar code scanner is configured to have LCD or LED screen to display the function and number being input.

8. The numeric dial quantity input device embedded bar code scanner as claimed in claim 1, wherein the numeric dial is configured to use a reference scale around the surface of the numeric dial for easy reference for the function and number being input.
